(19) United States
(12) Patent Application Publication
(10) Pub. No.: US 2008/0247337 A1
(43) Pub. Date: Oct. 9, 2008

(54) Method and Apparatus for Joint Detection in Downlink Tdd Cdma

(75) Inventors: Yueheng Li, Shanghai (CN); Gang Wu, Shanghai (CN); Xuejun Zhang, Shanghai (CN); Ni Ma, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,185

(22) PCT Filed: Mar. 4, 2005
(86) PCT No.: PCT/IB2005/500802

§ 371 Date: Sep. 22, 2006

(30) Foreign Application Priority Data
Mar. 25, 2004 (CN) 200410031343.0

(51) Int. Cl. H04J 3/00

(52) U.S. Cl. 370/280; 370/336

(57) ABSTRACT

A method and apparatus for implementing downlink JD (Joint Detection) in TDD CDMA communication systems, wherein the steps to be executed in the UE comprises: receiving downlink signals from a network system in a specific timeslot; acquiring the active primary and secondary channelisation codes in the specific timeslot, through processing the downlink signal; acquiring the initial ACC (Active Channelisation Codes) information for use in implementing JD in the next frame, through implementing a JD algorithm on the downlink signal by using the primary and secondary channelisation codes. An ACC dedicated channel is sent on the FPACH, carrying information relative to the use of secondary channelisation codes.

### FIELD OF THE INVENTION

The present invention relates generally to a communication method and apparatus for use in TDD CDMA systems, and more particularly, to a method and apparatus for implementing downlink joint detection in TD-SCDMA system.

### BACKGROUND ART OF THE INVENTION

In TDD CDMA (Time Division Duplex-Code Division Multiple Access) based wireless communication systems, there are mainly two intra-cell interferences: one is MAI (Multiple Access Interference), caused by sharing of the same frequency band by different users and loss of orthogonality between different channelisation codes allocated for different users due to multipath effects; another is ISI (Inter-Symbol Interference) between different paths of the same user, caused by multipath propagation.

To effectively mitigate MAI and ISI, JD (joint detection) is introduced into conventional TDD CDMA communication systems. JD takes full advantage of the channelisation codes, channel fading, signal delay and other information about the user signal, so it can improve signal transmission quality in the cell and increase TDD wireless communication system capacity. Furthermore, JD is suitable for TDD systems with various rates (such as 3.84M chips/s, 1.28M chips/s and 7.68M chips/s), and thus has become one of the key technologies in current TDD CDMA systems.

T3G, a joint venture organized by Datang, Philips and Samsung, has applied JD algorithms of ZF-BLE (Zero Forcing Block Linear Equalizer) and MMSE-BLE (Minimum Mean Square Error Block Linear Equalizer) to TD-SCDMA handset solution designs in her first 3G mobile products.

However, the implementation of ZF-BLE and MMSE-BLE algorithms needs to know as precondition the channelisation codes of all active UEs (User Equipments). But for the conventional signaling between the network system (UTRAN) and the UE, the radio resource allocation information associated with the destination UE is only defined in the radio link configuration message. That is, in current signaling structure, a UE can only know its own channelisation code and has no knowledge of the ACC (Active Channelisation Codes) used by other UEs sharing the same timeslot. Thus, it is not easy to implement JD algorithms in the UE.

To use JD algorithms in UEs, one solution is to add an additional “active code detection (ACD)” module in the receiver of a TD-SCDMA handset such that the ACC information can be recovered in a single UE. Apparently, this method is similar to blind-like detection, implemented at L1 (Physical Layer), which can greatly reduce the burden of the higher-layer signaling and acquire the ACC information independently during the initial call setup procedure when physical channels change due to resource reallocation. But recent researches show this ACD solution cannot attain ideal performance in some radio application environment. For example, the ACD method will lead to degradation of system performance in the following two cases: first, there is a large delay spread, which thus causes the maximum number K of the used midamble codes to be smaller, e.g. K=8 or 4; second, no beam forming or transmit diversity is applied in the BS (Base Station) and thus common midamble is allocated to all UEs within the same cell. As can be seen that application of the ACD method is very limited.

To overcome the drawback of the above ACD method, a method is proposed for the BS to send ACC information to UEs through common control channels such as BCH (Broadcast Channel), as described in the patent application document entitled “Mobile station enabled for use of an advanced detection algorithm,” filed by KONINKLIJKE PHILIPS ELECTRONICS N.V. on Jan. 13, 2003, European Application Serial No. 03075075.6. In accordance with the method as disclosed in the patent application, the channelisation code associated with a midamble can be obtained from the midamble allocation information. However, it is restricted to the so-called “default midamble” case, i.e. knowing the association between midambles and channelisation codes. There are two other midamble allocation schemes in 3GPP TDD standards: (i) common midamble, wherein all users sharing the same timeslot use the same midamble; (ii) UE specific midamble, wherein specific midamble is allocated to a UE by signaling from higher-layer applications. There is no fixed relationship between the channelisation codes and midambles in the two midamble The above allocation schemes can be referred to 3GPP Technical Specifications 25.221, “Physical Channels and mapping of transport channels onto physical channels (TDD)”, (Release 4), March, 2001. In these two cases, the ACC information can't be acquired by the UE with the method as disclosed in the patent application.

To address the restriction of the above method, another method is proposed, in which the BS embeds the ACC information into the data field as additional information symbol and then sends it to UEs, as described in the patent application document entitled “Method and apparatus for supporting downlink JD in TDD CDMA communication systems”, filed by KONINKLIJKE PHILIPS ELECTRONICS N.V. on Nov. 27, 2003, China Invention Patent Application Serial No. 200310118644.2. The method disclosed in this patent application is suitable for the above three midamble allocation schemes. In this method, only when the ACC information of a downlink timeslot changes, the base station will insert the changed ACC information into the data field of the corresponding timeslot and then send it to each UE in the downlink timeslot, thus to avoid overload of common channels and exempt the UEs in other timeslots from unnecessary computation and power consumption. But the current TDD frame structure has to be modified to be adapted to the method, and furthermore, the ACC information occupies data field, which will inevitably impair the data transmission rate or communication quality.

Therefore, a better communication method and apparatus are necessary to support the implementation of JD in the downlink of TD-SCDMA system.

### SUMMARY OF THE INVENTION

An object of the present invention is to provide a method and apparatus for implementing downlink JD in TDD CDMA communication systems, with which, the acquired ACC information can be utilized for executing JD algorithm, thus to reduce the influence of the intra-cell interference upon the destination UE and enlarge system capacity.

Another object of the present invention is to provide a method and apparatus for implementing downlink JD in TDD CDMA communication systems, with which, even a UE in the initial call setup procedure can acquire the ACC information and other UEs communicating in the same timeslot can also obtain accurate ACC information.

A third object of the present invention is to provide a method and apparatus for implementing downlink JD in TDD CDMA communication systems, with which, accurate ACC information can be acquired when UEs in the same timeslot use common midamble or specific midamble.

A fourth object of the present invention is to provide a method and apparatus for implementing downlink JD in TDD CDMA communication systems, with which, the UE can also acquire the actual ACC information in the case that downlink beam forming is applied at the base station.

A method is proposed in the present invention for a UE to perform downlink JD in TDD CDMA communication systems, comprising: (a) receiving downlink signals from a network system in a specific timeslot; (b) acquiring the active primary and secondary channelisation codes in the specific timeslot through processing the downlink signals; (c) performing a JD algorithm by taking advantage of the primary and secondary channelisation codes, to obtain the initial ACC information for use of performing JD in the next radio frame.

Wherein step (c) further includes: performing JD algorithm on said downlink signal sent by the network system via an ACC dedicated channel, by taking advantage of the primary and secondary channelisation codes, to obtain the initial ACC information; the ACC dedicated channel has two code channels within the specific timeslot and the midamble corresponding to a pair of channelisation codes used by the two code channels is not only different from the midamble used by the BCH, but also different from the midambles the BS reserves for the BCH when it adopts transmit diversity.

In accordance with the above method of the present invention, steps further include: executing JD algorithm on the ACC dedicated channel by taking advantage of the initial ACC information in the next radio frame, to get the ACC information for use in a subsequent radio frame; executing a JD algorithm on the signal received in the next radio frame from the network system, by taking advantage of the initial ACC information, to demodulate the information from the network system.

A method is proposed in the present invention for the network system to perform downlink JD in TDD CDMA communication, comprising: predicating the ACC information of each timeslot in the next radio frame; sending the ACC information in a specific timeslot via an ACC dedicated channel constructed by pre-selected code channels; wherein the pre-selected code channels are two code channels in the specific timeslot and the midamble corresponding to a pair of channelisation codes used by the two code channels is not only different from the midamble used by the BCH, but also different from the midambles the BS reserves for the BCH when it adopts transmit diversity.

Other objects and attainments together with a fuller understanding of the invention will become apparent and appreciated by referring to the following descriptions and claims taken in conjunction with the accompanying drawings.

### BRIEF DESCRIPTION OF THE DRAWINGS

For a detailed description of the preferred embodiments of the invention, reference will now be made to the accompanying drawings in which like reference numerals refer to like parts, and in which:

FIG. 1 is a flowchart illustrating the call setup procedure between the UTRAN and the UE to be performed at the UE side in TD-SCDMA system;

FIG. 2 shows the resource allocation for the downlink physical channel in TD-SCDMA system;

FIG. 3 shows the subframe and timeslot structure used in TD-SCDMA system;

FIG. 4 displays the association between the midambles and the channelisation codes in TD-SCDMA system when the midambles are allocated in the default way and the maximum number of midambles is 8;

FIG. 5 illustrates the mapping procedure for the transmission of 12.2 Kbps voice data in one TTI (20 ms) in TD-SCDMA system;

FIG. 6 illustrates the location of the ACC channels and their allocated channelisation codes in TD-SCDMA system in accordance with an embodiment of the present invention;

FIG. 7 illustrates the demodulation and ACC acquisition for each downlink physical channel during one UE's call setup procedure in accordance with an embodiment of the present invention;

FIG. 8 illustrates the call setup procedure with reading ACC info to be performed at the UE side in accordance with an embodiment of the present invention;

FIG. 9 illustrates the demodulation and ACC acquisition for each downlink physical channel during one UE's call setup procedure in accordance with another embodiment of the present invention;

FIG. 10 illustrates the call setup procedure with reading of ACC info to be performed at the UE side in accordance with another embodiment of the present invention;

FIG. 11 illustrates the mapping between the number of channelisation codes and the midamble shift in TD-SCDMA system in the case of common midamble (K=8);

FIG. 12 illustrates the higher-layer signaling procedure for transmission and processing of the ACC information during implementing downlink JD procedure in TD-SCDMA system in accordance with the embodiments of the present invention;

FIG. 13 shows the architecture of the network system and UE for acquiring ACC information in TD-SCDMA system to implement JD algorithms in accordance with an embodiment of the present invention.

### DETAILED DESCRIPTION OF THE INVENTION

In the downlink of TDD CDMA system in the present invention, through setting up an ACC dedicated channel in a specific timeslot, the network system can send the predicted ACC information in the next radio frame directly to the UE via the ACC dedicated channel. The UE determines the active primary and secondary channelisation codes in the specific timeslot, and then utilizes the determined active primary and secondary channelisation codes to execute a JD algorithm on the ACC dedicated channel, thus to get the initial ACC information. In the next radio frame, by utilizing the initial ACC information, the UE can execute JD algorithm on the ACC dedicated channel, thus to get the ACC information for use in a subsequent radio frame, and execute a JD algorithm on the received signals from the network system, to demodulate the information from the network system.

In the following sections, TD-SCDMA system will be exemplified to describe the proposed method for establishing ACC dedicated channel, the method for determining which primary and secondary channelisation codes are active in the specific timeslot, and the method for determining accurate ACC information when a new FPACH (Fast Physical Access Channel) is activated and the network system applies beam forming or common midamble allocation scheme to send signals.

Setup of ACC Dedicated Channel

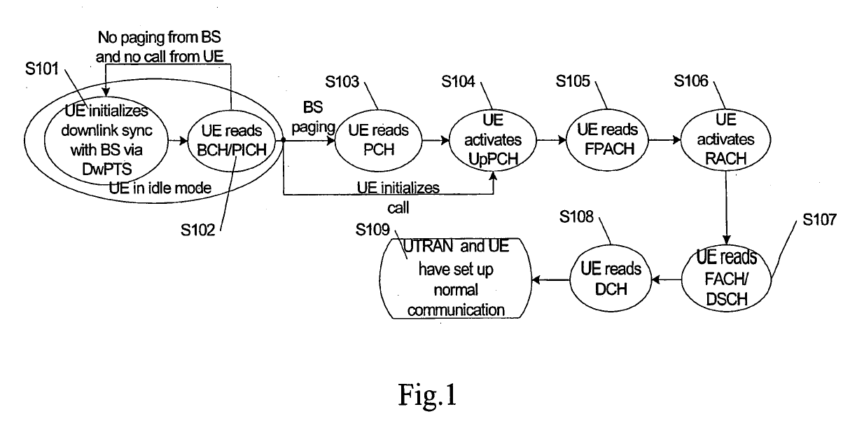

FIG. 1 illustrates the operations to be performed by a UE during call setup procedure between the UTRAN and UE, which begins from the UE's idle mode. While in idle mode, the UE will keep performing part of or the whole cell search procedure, comprising: realizing downlink synchronization with the base station, identifying the scramble code and basic midamble used by the cell, and achieving multi-frame synchronization (step S101). Then, the UE reads the system information in the BCH and the information in the Paging Indication Channel (PICH), to decide whether the base station has ever paged it (step S102). If the base station has sent paging message to the UE, then the UE reads the information in the Paging Channel (PCH) indicated by the PICH (step S103). If the UE has initiated call request to the base station or has already obtained the information in the PCH, the UE sends uplink synchronization code to the base station via the Uplink Pilot Channel (UpPCH), to establish uplink synchronization (step S104). On receipt of the UpPCH, the base station instantly returns ACK message to the UE via Fast Physical Access Channel (FPACH) within four subsequent subframes. After sending out the uplink synchronization code, the UE will wait to receive FPACH traffic burst on the FPACH from the next subframe on (step S105). After receiving the ACK message over the FPACH, the UE learns that the call setup request has been accepted, and then begins to send connect request message to the base station via Random Access Channel (RACH) mapped onto Physical Random Access Channel (PRACH), according to the transmit power indication and timing advance obtained from the FPACH (step S106). After correct PRACH processing, the base station will initiate Forward Access Channel (FACH) and/or Downlink Synchronization Channel (DSCH) communication to transmit some mandatory configuration messages to the UE for use in preparatory communication procedure, such as the radio bearer setup, reconfiguration and etc (step S107). These configuration messages will be transmitted over Dedicated Control Channel (DCCH) in the logic channel, which can only be mapped to transport channels of FACH or DSCH before normal data communication is established between the UTRAN and the UE. After receiving these messages, the UE returns a confirmation signal to the network according to higher-layer commands (or returns nothing according to the specific requirement of the base station), and afterwards reads information from Data Channel (DCH) (step S108), thus enters into normal communication with the UTRAN (step S109).

In the call setup procedure as shown in FIG. 1, each transport channel will be mapped onto different physical channel, wherein some physical channels are finally mapped into timeslots of Physical Layer after multiplexing.

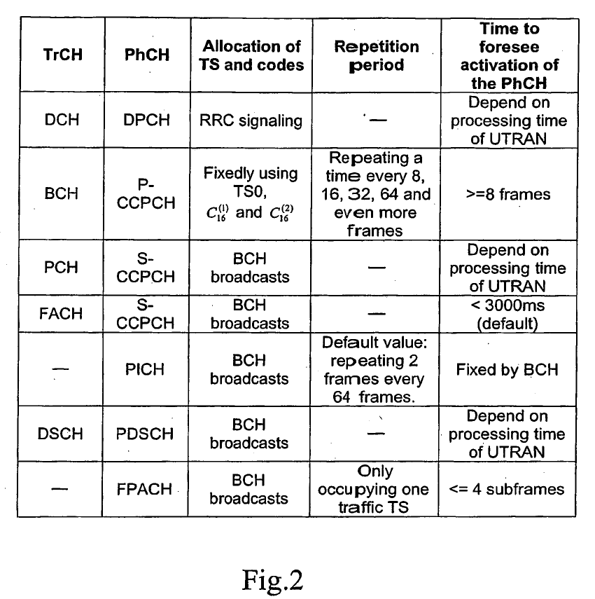

FIG. 2 summarizes the various radio resource allocation cases of each downlink physical channel involved during call setup procedure, including: the timeslots and channelisation codes of each physical channel, the repetition period of the channel, and the activation time of the channel foreseen at the UTRAN side. Meanwhile, the mapping between each transport channel and the related physical channel is also listed in FIG. 2. As shown in FIG. 2, for example, Forward Access Channel (FACH), the transport channel for transferring control information to UEs, is mapped onto Secondary Common Control Physical Channel (S-CCPCH). And the timeslot location and available channelisation codes of S-CCPCH are broadcasted to UE over BCH in the related section of system configuration message. In default, the reaction time for BS between receiving PRACH and sending FACH is less than 3000 ms.

During a normal communication procedure, when a new user begins call setup procedure, the UTRAN should announce the new ACC information to all UEs allocated within the same downlink timeslot as the new user so that each UE can perform JD algorithm by exploiting the new ACC information. Obviously, using existing common control channel (such as BCH) can be an easy implementation to carry the new ACC information. But as seen from FIG. 2, BCH, FACH, PCH, DSCH and PICH all have very long repetition period, for example, since the minimum repetition period of BCH is 8 radio frames in duration, it will be very difficult to timely reflect change of channelisation codes under some complicated circumstances if the ACC information is transferred with this update rate. Furthermore, except BCH, radio resource allocation for each other channel is irregular. Considering the update rate for ACC information, the above channels are not suitable for transferring ACC information, thus it's necessary to set up an ACC dedicated channel for transferring ACC information, so as to meet the requirement for transferring the changed ACC information timely in practical applications.

The setup of ACC dedicated channel is mainly related with the timeslots occupied and the channelisation codes used by the ACC dedicated channel.

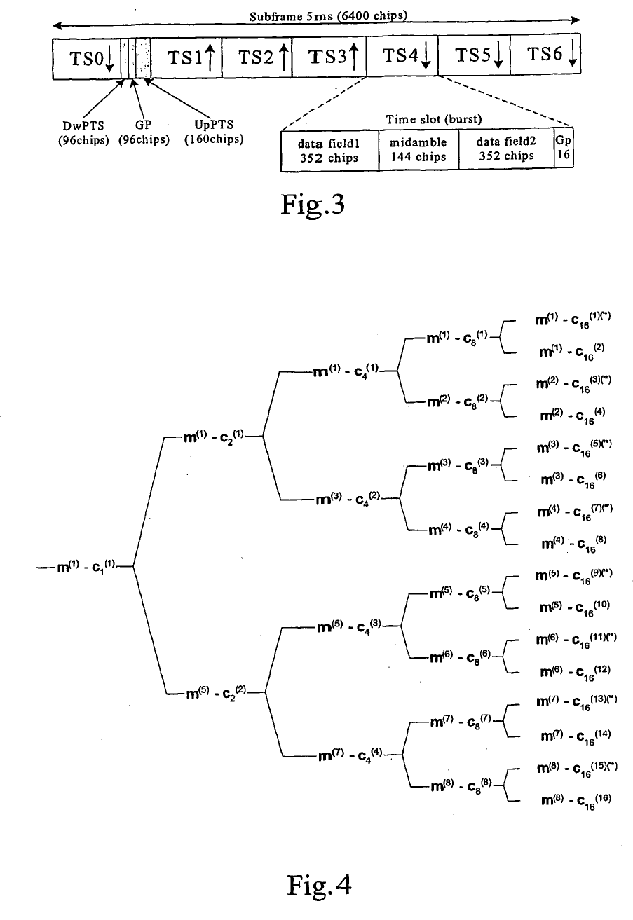

FIG. 3 illustrates the subframe and timeslot structure in TD-SCDMA system. In TD-SCDMA system, the length of a radio frame is 10 ms and it is divided into 2 subframes of 5 ms, as indicated in FIG. 3. Every subframe includes four kinds of timeslots, Downlink Pilot Timeslot (DwPTS), Uplink Pilot Timeslot (UpPTS), Guard Period (GP) and seven traffic timeslots TS0˜TS6. DwPTS and UpPTS are respectively for downlink and uplink synchronization without carrying user data, and the GP between them is for transmission delay guard during uplink and downlink synchronization establishment procedure. Every traffic timeslot in TS0˜TS6 includes two data fields (with each data field as 352 chips) and the midamble embedded between them (144 chips), wherein the data fields are for carrying user data or control information whereas the midamble is for channel estimation.

With respect to the seven traffic timeslots in FIG. 3, TS0 is always for downlink information delivery according to the specifications of the communication protocols, so we can choose to deliver ACC information in TS0. In addition, according to the specifications of 3GPP standards, all physical channels in TS0 will invariably use the default midamble allocation scheme with midamble number K=8, i.e. there is a fixed association relationship between the midambles and channelisation codes. The default midamble allocation scheme, in fact, further consolidates the foundation of setting up ACC dedicated channel in TS0.

FIG. 4 displays the allocation of midamble m and its corresponding channelisation code c when the spreading gain is 1, 2, 4, 8 and 16 (i.e. SF (spreading factor)=1, 2, 4, 8, 16) respectively. According to the specifications of 3GPP communication protocols, there are only two allocation schemes for downlink as SF=1 and SF=16, whereas SF=1 exists only when a single user is present in the cell and a high-speed transmission of 2 Mbps occurs (there is no JD at this moment), so we only consider the case SF=16 in the present invention. When K=8 and SF=16, the association between the midambles and channelisation codes is shown in the most right column, wherein channelisation code with superscript (′*) is secondary code and the other is primary code. When channelisation codes are being allocated, the network system always prefers to allocate the primary code to UE.

After the timeslot allocated for the ACC dedicated channel is decided, we further need determine the available channelisation codes among the 16 channelisation codes in TS0 for use in the ACC dedicated channel, according to TS0's characteristics.

Referring to FIG. 4, the Orthogonal Variable Spreading Factor (OVSF or the usually referred orthogonal spreading code) C₁₆⁽¹⁾ and C₁₆⁽²⁾ corresponding to midamble m⁽¹⁾ are used for transferring data over BCH, i.e. channelisation codes C₁₆⁽¹⁾ and C₁₆⁽²⁾ are the reserved code channels of BCH and can't be used by the ACC dedicated channel. And the channelisation codes C₁₆⁽³⁾ and C₁₆⁽⁴⁾ corresponding to midamble m⁽²⁾ can't be applied to ACC either, because m⁽²⁾ will be regarded by the system as the midamble transmitted over the other antenna due to the fact that redundant BCH information is required to be sent through the other antenna to obtain gain when the base station adopts block space time transmit diversity (Block STTD) technique. If channelisation codes C₁₆⁽³⁾ and C₁₆⁽⁴⁾ are used to transfer ACC information (need be transferred uninterruptedly) and at the same time the base station happens to adopt BCH transmit diversity technique, then the UE can't determine whether the base station adopts transmit diversity according to the detected m⁽²⁾ after the UE performs channel estimation on the received signal. BCH can be recovered by ignoring transmit diversity, but this will inevitably affect the normal reception of BCH under certain circumstances.

As can be seen from the above characteristics of TS0, we can only choose channelisation codes except C₁₆⁽¹⁾, C₁₆⁽²⁾, C₁₆⁽³⁾ and C₁₆⁽⁴⁾, i.e. the channelisation codes from C₁₆⁵ to C₁₆⁽¹⁶⁾ for use in the ACC dedicated channel.

When deciding the channelisation codes available for ACC dedicated channel, we should also consider the number of channelisation codes used for transferring ACC information, besides that the chosen channelisation codes shouldn't produce conflicts with current communication standards.

In a normal communication, the number of channelisation codes is related with the number of the allocated downlink timeslots, and the transmission time interval (TTI) as well.

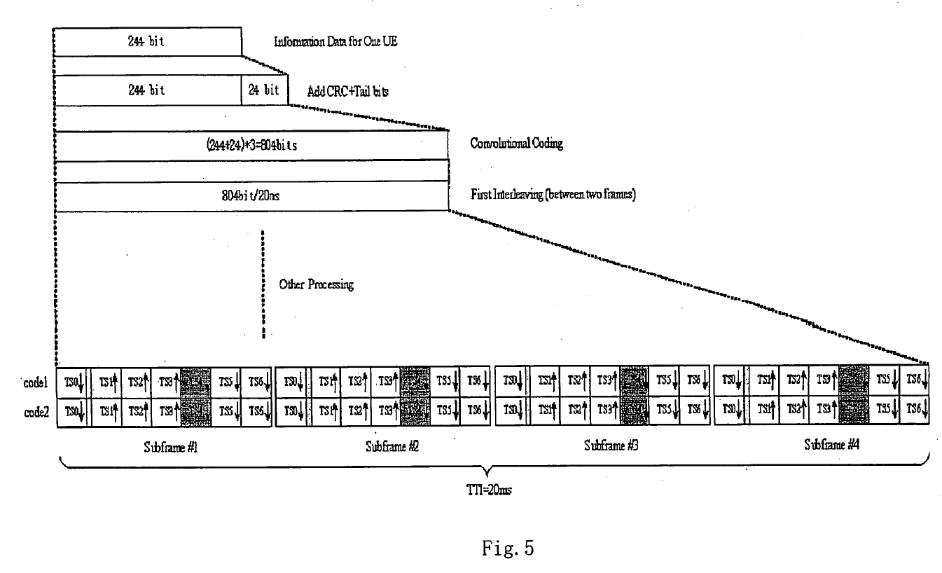

In conjunction with FIG. 5, the following section will describe the procedure of transferring the 244 bits original data when the TTI is 20 ms, by exemplifying the procedure of mapping 12.2 kbps UE speech data stream onto the dedicated physical channel (DPCH).

As shown in FIG. 5, first, append cyclic redundancy check code (CRC) of 16 bits and 8 tail bits at the end of the 244-bit original data block; after a convolutional coding of ⅓ chip rate and first interleaving, divide the 804 ((244+16+8)*3)=804) bits data into two radio frames; next, after subsequent rate matching, multiplex processing and second interleaving, allocate the interleaved bit stream averagely into four timeslots in the four subframes, as shown in FIG. 5, for instance, allocate it averagely into TS4 in each subframe.

During the processing procedure shown in FIG. 5, the first interleaving is very important. After the first interleaving, the 804 bits data is mapped into two radio frames (20 ms), which shows that in order to recover the 244 bits original data through de-interleaving and convolutional decoding, the UE must receive the data in four TS4s in four consecutive subframes. Here, the first interleaving period (i.e. 20 ms) is called a TTI. In current 3GPP TDD standard, there are totally four kinds of definitions for TTI: 10 ms, 20 ms, 40 ms and 80 ms respectively.

Since the shortest TTI is 10 ms, when radio source controller (RRC) allocates TTIs to the physical channels relevant to different UEs, the starting points of the TTIs begin with odd subframe number, for example, subframe #1 or #3 shown in FIG. 5, then the ACC information will not change at least in one radio frame (10 ms). For instance, with regards to the subframe numbering in FIG. 5, if one or more new UEs initiate calls and want to enter into the current timeslot in the normal communication procedure of current TTI, the new UE can only start either from subframe #3 in current TTI or subframe #1 in the next TTI according to the above rule, no matter TTI of 10 ms, 20 ms or more long time are allocated to the new UE. Assuming the new UE starts from subframe #3 in the current TTI, there will be no change in the channelisation codes information during the 10 ms of subframe #1 and #2 when the former UE receives downlink signals at this time duration. That means the system ACC information will remain unchanged at least in one radio frame (10 ms).

Based on the above rule that the ACC information will keep unchanged in one frame (10 ms), in the case that the minimum TTI is 10 ms, there are 6 downlink timeslots at most in a subframe and there are 16 channelisation codes at most in a timeslot, thus the maximum transmission rate of ACC information is (6*16)/10 ms=9.6 Kbps. As specified in the communication protocol, two code channels are needed to transfer information of 9.6 Kbps in a 1.28 Mbps TD-SCDMA system, which indicates the transmission load of ACC information is rather heavy, and no current common control channel alone can carry so much appended information.

As analyzed above, ACC dedicated channel should use any pair of channelisation codes corresponding to the midamble in TS0, except C₁₆⁽¹⁾, C₁₆⁽²⁾, C₁₆⁽³⁾ and C₁₆⁽⁴⁾.

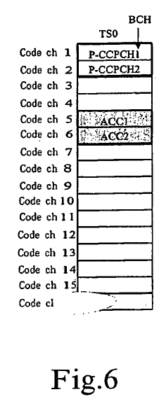

In the following, a description will be given to the procedure of reading ACC information in the ACC dedicated channel, by exemplifying code channels 5 and 6 as the ACC dedicated channel, with reference to FIG. 6 which illustrates the allocation of channelisation codes in TS0 in TD-SCDMA system.

II Reading ACC Information Transferred Through ACC Dedicated Channel

According to the specification of TDD standard, the total transmission power of a downlink timeslot is limited, and in order to guarantee that the BCH information can be transmitted to the whole cell, the transmission power of BCH is always higher than that of other physical channels (including ACC dedicated channels), so the ACC dedicated channels in TS0 must be processed by JD algorithm instead of the conventional Rake receiver. However, usage of JD for processing ACC dedicated channels needs to know the information of active channelisation codes in TS0 in advance, and obviously, the ACC information embedded in ACC dedicated channels cannot be utilized by the current 10 ms frame, that is, the ACC information broadcasted in the current frame can only be used for the next frame.

As to whether the UTRAN can foresee the ACC change in the next frame so as to embed the changed ACC information into the ACC dedicated channels of the current frame, it can be referred to FIG. 2. As can be easily seen from FIG. 2, except that FPACH is required to make response within time less than 4 subframes which relates to operations on physical layer and needn't be processed by the high-layer, the UTRAN can control and foresee the radio resource allocation information of other downlink physical channels (such as timeslot location and channelisation codes). Thus, the UTRAN can transmit the predicated ACC information of the next frame to each UE via the ACC dedicated channel in the current frame, so that the UEs can perform JD in the next frame.

But there is still a problem: how UE can acquire the initial ACC information of TS0 in the initial call setup procedure so as to demodulate the ACC dedicated channels and other physical channels in the next frame by using the initial ACC information. And there are two solutions proposed in the present invention.

During the initial call setup procedure, all ACC in TS0 must be known for performing JD algorithm on the ACC dedicated channels in TS0. Since TS0 adopts the default midamble allocation scheme with K=8, we can know whether the 8 primary channelisation codes in TS0 are activated according to the active midambles obtained through channel estimation and the association between midambles and channelisation codes. Only through channel estimation, it will be very difficult to determine whether the 8 secondary channelisation codes are activated. The above two solutions of the present invention are proposed, focusing on whether the secondary channelisation codes are activated.

1. Fixed Radio Resource Allocation Scheme Adopted in TS0

In accordance with TDD specification, the midamble in TS0 is designated as the default midamble with K=8, where one midamble corresponds to two channelisation codes. As shown in FIG. 4, for example, m⁽³⁾ corresponds to channelisation codes C₁₆^{(5)(*)} and C₁₆⁽⁶⁾.

If the communication protocol is modified such that TS0 has to use the fixed channelisation codes allocation rule, that is, two channelisation codes associated with one midamble must be allocated to one UE at the same time and allocation of only the primary code to UE is forbidden, then all primary and secondary channelisation codes of TS0 can be easily identified according to the midambles detected through channel estimation and the association between midambles and channelisation codes. And thus the ACC information of the next frame can be acquired by performing JD on the ACC dedicated channels in TS0, using the active primary and secondary channelisation codes.

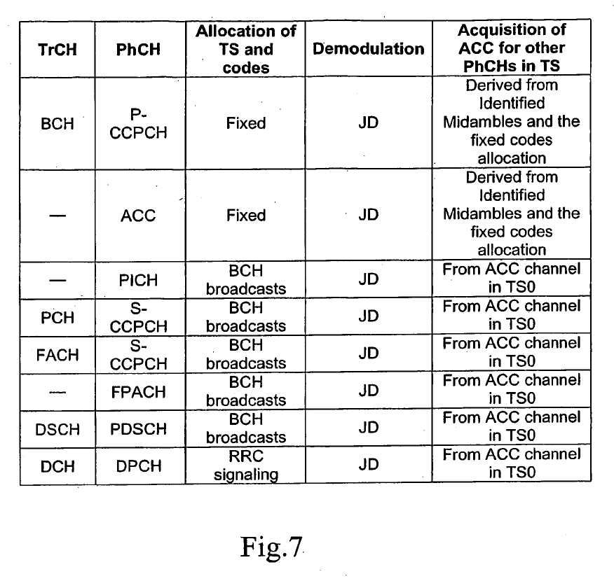

Then in the next frame, the UE can perform JD on each physical channel by using the ACC information acquired in the previous frame, to demodulate the signals sent by the UTRAN, and perform JD on the ACC dedicated channel to acquire the ACC information of the subsequent frame, for the subsequent frame to execute JD algorithm. As to the demodulation method adopted by each physical channel and the source of the ACC information used for executing JD, it can be referred to FIG. 7.

As FIG. 7 illustrates, the physical channels, such as ACC channel (after the initialization procedure is accomplished), PICH and S-CCPCH, can use the acquired ACC information above to read the transferred information through executing JD algorithm.

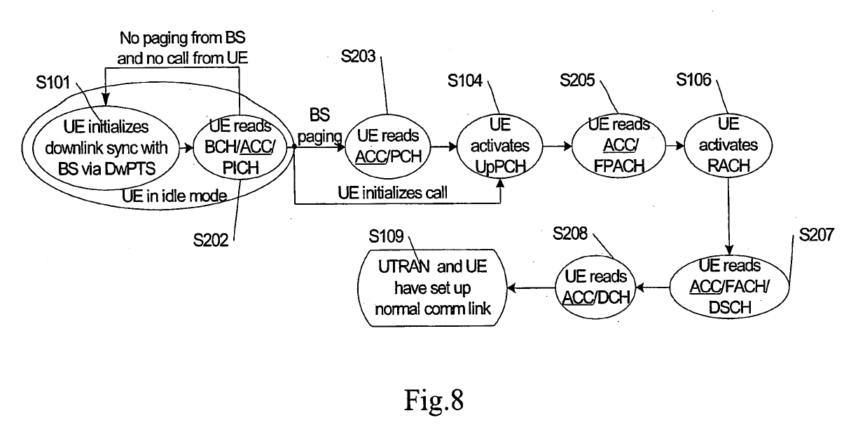

If the initial ACC information is acquired with this solution, the UE's call setup procedure can be illustrated in FIG. 8. In order to demodulate PCH in step S203, FPACH in step S205, FACH/DSCH in step S207, and DCH in step S208, UE needs to perform JD on these channels by using the ACC information of the previous frame delivered over the ACC dedicated channel.

Of course, implementation of this solution relies on the mandatory specification that only full-rate speech traffic with 12.2 kbps, or other data traffics such as 32 kbps, 64 kbps etc are allowed, each of which only consumes even code channels.

2. Transferring Information of the Secondary Channelisation Codes by Using Reserved Bits in FPACH

Referring to the foregoing description, TS0 uses the default midamble al location scheme with K=8, and BCH and ACC dedicated channel occupy four code channels totally, which correspond to two midambles m⁽¹⁾ and m⁽³⁾ respectively. As FIG. 4 shows, besides the two midambles reserved for BCH and ACC channel, there are still six midambles left in TS0, as m⁽²⁾, m⁽⁴⁾˜M⁽⁸⁾. Here, m⁽²⁾ can only be used by other channels when transmit diversity is not applied, and the channelisation codes corresponding to the six midambles are C₁₆^{(3)(*)}, C₁₆⁽⁴⁾, C₁₆^{(7)(*)}, C₁₆⁽⁸⁾, until to C₁₆^{(15)(*)} and C₁₆⁽¹⁶⁾ respectively.

Since the primary channelisation codes (without superscript *) can be determined by the midambles detected from channel estimation, the uncertainty of channelisation codes are just coming from the remaining secondary channelisation codes, that is, C₁₆^{(3)(*)}, C₁₆^{(7)(*)}, C₁₆^{(9)(*)}, C₁₆^{(11)(*)}, C₁₆^{(13)(*)}, and C₁₆^{(15)(*)}. If we could have one 6-bit bitmap to indicate whether these undetermined secondary codes in TS0 are used by users or not, in combination with the primary codes information determined through the identified midambles, all ACC in TS0 can be determined.

In fact, there happens to be 9 reserved bits in FPACH information, with which we can construct a 6-bit bitmap b₁b₂b₃b₄b₅b₆ of secondary codes used in TS0 in the next 10 ms frame of the frame where the FPACH is located, with each bit indicating whether the related secondary code is active or not. For example, when transmit diversity is not applied to BCH and midamble m⁽²⁾ is identified, b₁ in the bitmap will be checked. If b₁=1, it means C₁₆^{(3)(*)} is active, while b₁=0 represents not active. The meaning and usage of other indicative bits are similar to this simple example.

There are two points necessary to be noted that: first, the corresponding bits should be read only when affiliated midambles in TS0 are detected out in the UE; secondly, since FPACH is a pure physical layer reaction, the physical layer of the UTRAN must keep the ACC information of the current 10 ms frame where the FPACH is located, for the FPACH to create the 6-bit bitmap of secondary codes, so as to facilitate detection of ACC channels in the next 10 ms frame.

By using the mapping information of the secondary channelisation codes carried by the FPACH and the primary channelisation codes information determined by the identified midamble, we can determine all primary and secondary channelisation codes to be used by TS0 in the next 10 frame of the frame where the FPACH is located. Thus, we can perform JD on the ACC dedicated channels in TS0 by utilizing the active primary and secondary channelisation codes, to acquire the ACC information for the next frame.

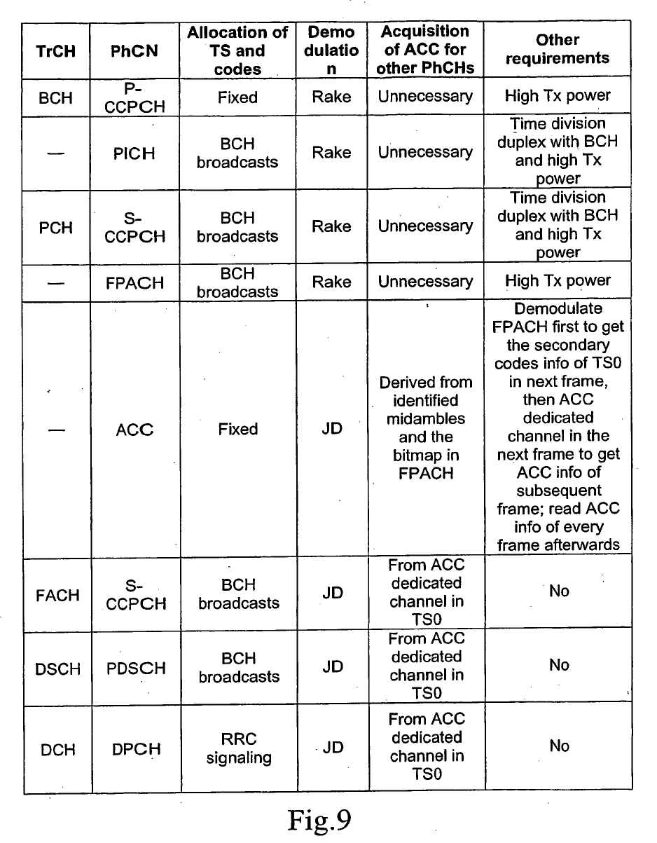

Then, in the next frame, UE can perform JD on each physical channel by using the ACC information acquired in the previous frame, to demodulate the signals sent by the UTRAN, and perform JD on the ACC dedicated channels to acquire the ACC information of the subsequent frame, for the subsequent frame to execute JD algorithm. As to the modulation method adopted by each physical channel and the source of the ACC information utilized for implementing JD, it can be referred to FIG. 9.

As shown in FIG. 9, transport channels like BCH, PCH and physical channels like PICH need use Rake receiver to demodulate the information transferred over the channels. Only after reading the secondary channelisation codes information carried in the FPACH information, can the ACC information in the ACC dedicated channels be read with JD method, and can JD algorithm be executed on the ACC channel and S-CCPCH physical channels to read the information transferred over the channels, by using the ACC information.

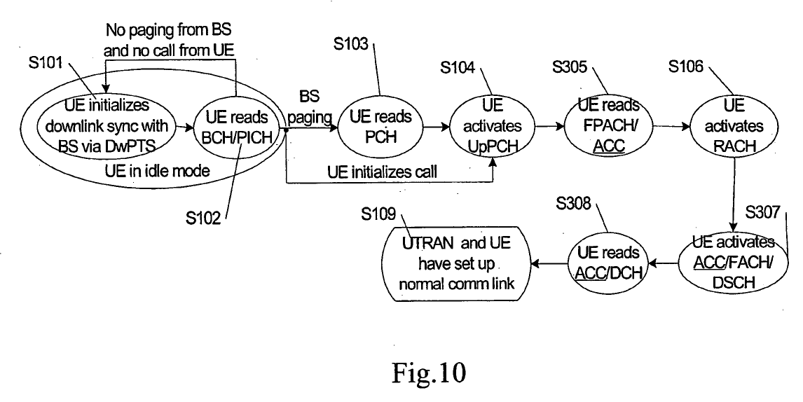

If the second solution is adopted to acquire the initial ACC information, the UE's call setup procedure can be illustrated in FIG. 10. Different from the first solution, before UE obtains the FPACH information, the ACC information is unknown. Therefore, all the channels enabled before the FPACH need employ Rake receiver for demodulation, and PCH is also required to transmit with the same high transmission power as the BCH. After receiving the FPACH information, UE can use the bitmap information carried in the FPACH, combining with the identified midambles, to perform JD on the ACC dedicated channels in the next frame in step S305, so as to acquire the ACC information of the next frame. And thus in the next frame, the ACC information can be utilized to perform JD on FACH/DSCH in step S307 and on DCH in step S308, to obtain information in the corresponding channels.

III Executing JD Algorithm by Using the ACC Information

As the above description to the ACC dedicated channels in conjunction with FIG. 2, in the physical channels shown in FIG. 2, the FPACH is a special response channel, only for responding the access request in the UpPCH, without carrying information of the transport channels. The channel parameters (such as timeslot, channelisation code, midamble shift and etc) used by the FPACH are embedded in the system information and are broadcast to UEs. The duration time of the FPACH is limited within 5 ms, that is, it only occupies one FPACH traffic burst in a radio subframe.

Since the base station is required to make fast response to the access request within time less than four subframes, FPACH is totally related with physical layer operations of the UTRAN and the higher layer can't know in advance whether FPACH is sent out or not. So, the active channelisation codes information about the FPACH is unlikely to be included in the ACC information for broadcasting the change in the channelisation codes information of the next frame and transferred over the ACC dedicated channels of the current frame, i.e. the active FPACH channelisation codes are not included in the information delivered over the ACC dedicated channels.

For UE communicating in the downlink timeslot, it can learn in advance the timeslots, channelisation codes, midamble shift and etc of the FPACH, which are likely to exist in the current subframe, from the system information broadcasted over BCH. In every subframe, a FPACH only occupies one timeslot, and in the timeslot FPACH only uses one channelisation code, and usually only one FPACH exists in a subframe, so UE can identify whether the FPACH broadcasted in the timeslot is active through the midamble shift detected by the channel estimator, if the timeslot adopts the default midamble or specific midamble.

As stated above, according to the system information broadcasted over BCH, UE has known in advance the information about the timeslots, channelisation codes, midamble shift and etc reserved for the FPACH by the UTRAN, then the destination UE will perform JD on each physical channel to get the downlink information sent from the UTRAN by using the detection result of the ACC codes and the FPACH channelisation codes included in the ACC information transferred over the ACC dedicated channel in the previous frame, in the corresponding downlink timeslot in which FPACH is likely to be included. For those downlink timeslots not including FPACH, JD will be performed on each physical channel to get the downlink information sent by the UTRAN, by using the ACC codes included in the ACC information transferred over the ACC dedicated channel in the previous frame.

IV Factors Affecting Accurate Acquisition of the ACC Information

As described above, during communication procedure, the ACC information used in implementing JD includes two parts: the ACC information from the ACC dedicated channel and the active FPACH channelisation codes, so the factors that will affect the accurate acquisition of the ACC information are also related with the two aspects.

The influence upon the ACC information of the ACC dedicated channel mainly arises from the case where the base station transmits signals with downlink beam forming, and the influence upon identifying the active FPACH channelisation codes is mainly related with the case where common midamble allocation scheme is used in the cell. Descriptions will be given below to the two aspects.

1. Acquisition of the ACC Information when Common Midamble Allocation Scheme is Used in the Cell

Usually, the network system adopts common midamble allocation scheme only when the base station uses single antenna for omni-directional cell coverage.

The default midamble with K=8 is still designated for use in TS0 (this specification has no influence upon single antenna transmission), and the common midamble in the cell is only applied in other timeslots except for TS0, so utilization of the common midamble allocation scheme won't produce influence upon the acquisition of the ACC information of the ACC dedicated channels in TS0.

However, other physical channels such as FPACH, DPCH and FACH and etc in the same timeslot except TS0 will use the same midamble and there exists no any association between midambles and channelisation codes like that in “default midamble” at this time. In these physical channels, the ACC information for DPCH can be acquired through the dedicated ACC channels in TS0. But the problem to be settled in implementing JD algorithm by using accurate ACC information, is how we can obtain the FPACH channelisation codes which are not included in the ACC information carried over the ACC dedicated channels and need be acquired through detecting the midamble. Two methods are proposed in the present invention and will be described below.

(1) Utilizing the Existing Specification about the Number of Downlink Channelisation Codes in the Protocol

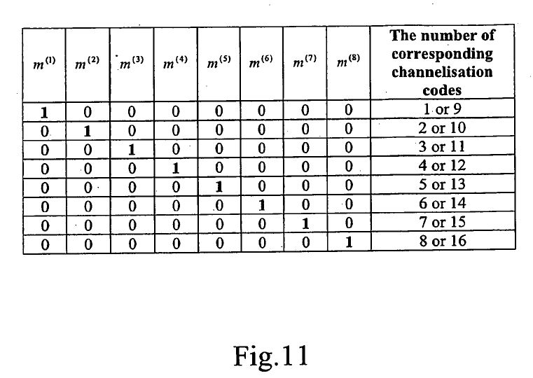

FIG. 11 illustrates the signaling mapping scheme when there are at most 8 midambles permitted in the cell. For instance, if a timeslot chooses m⁽¹⁾ as the common midamble, it means there are 1 or 9 channelisation codes in the timeslot, but only the number of channelisation codes is indicated in this signaling, without any further coding information. From TDD standard, it can be known that the allocation of common midamble is the operation of physical layer, which means physical layer of the UTRAN can signal UE about the number of the actual channelisation codes in the timeslot through changing the shift of the common midamble, if FPACH is activated in the timeslot.

For example, if RRC layer of the UTRAN finds there are 8 active channelisation codes in a timeslot, it will encode the channelisation codes information into corresponding bitmap to be transmitted in the ACC dedicated channel in TS0. If no FPACH is found to be active in the timeslot when physical layer of the UTRAN is preparing to send information of the timeslot, m⁽⁸⁾ will be taken as the common midamble of the timeslot according to the number of channelisation codes. However, if the UTRAN has responded the call request of a UE and is going to send FPACH (i.e. FPACH is already activated), the number of channelisation codes in this timeslot will change from 8 to 9. And at this moment, physical layer will replace m⁽⁸⁾ with m⁽¹⁾ corresponding to 9 channelisation codes to act as the common midamble of the timeslot, just as shown in FIG. 11.

Assuming the above case where there exists active FPACH, when a UE learns the network system adopts common midamble according to the system information broadcasted over BCH and receives signals sent by exploiting common midamble, after the UE detects midamble m⁽¹⁾ of the timeslot with channel estimator, it can determine the 1 or 9 active channelisation codes in the timeslot with reference to the number of channelisation codes represented by m⁽¹⁾ as shown in FIG. 11. But only 8 channelisation codes can be acquired from the ACC information obtained through the ACC dedicated channel, thus it can be seen that the FPACH channelisation codes in the timeslot signaled over BCH broadcast have been activated in the timeslot.

(2) Designating Midamble for FPACH

This method is to designate a specific midamble, for example m⁽⁷⁾, for a call requesting UE through signaling over BCH. That is, the m⁽⁷⁾ is dedicated to FPACH.

When the UE knows that the network system adopts comma n midamble and has already designated midamble m⁽⁷⁾ for FPACH according to the system information broadcasted over BCH, after receiving signals, the UE can detect midamble m⁽⁷⁾ through channel estimation so as to determine that the FPACH channelisation codes broadcasted over BCH have been activated in the timeslot.

Obviously, the usage of specific midamble like m⁽⁷⁾ makes it impossible that there are 7 or 15 codes in one timeslot, that is, the number of the active channelisation codes in a TS is forbidden to be 7 or 15.

2. Determining the Actual Active ACC in the Case of Downlink Beam Forming

Beam forming is one of the key technologies of TD-SCDMA. When downlink beam forming is applied, the communication protocol specifies that common midamble allocation scheme is prohibited in a cell, and only the two schemes of the default midamble and specific midamble allocation can be allowed.

In the case of beam forming, the beam focused on the desired UE will cancel part of the interferences caused by other UEs, compared to omni-directional beam. For example, in the base station, if the mixed transmitting signals are constructed by 8 code channels of several UEs, then the effective received signals at the destination UE may only comprise 6 original code channels, and the other two may be ignored due to the interference suppression of beam forming (the result of beam forming depends on the direction angle constructed by the destination user and other users and the base station antenna, or namely the beam coverage range of the base station smart antenna). At this time, however, if JD is preformed by still using the original 8 channelisation codes included in the ACC information from ACC dedicated channel, the performance of JD will be severely affected.

In this situation, the present invention proposes to combine the acquired ACC information with the detected midamble, to identify the actual remaining channelisation codes in the case of downlink beam forming. Let's still take the aforementioned case of 8 code channels as an example. Assuming the number of midambles K=8, four UEs with midambles m⁽¹⁾ to m⁽⁴⁾ respectively, and the midambles corresponding to 8 channelisation codes, when a UE, upon receipt of signals, first detects the midamble with channel estimator. If only m⁽¹⁾, m⁽³⁾ and m⁽⁴⁾ are identified by channel estimation and midamble m⁽²⁾ is not detected (m⁽²⁾ is cancelled due to downlink beam forming), and the UE knows that there are totally 8 channelisation codes (C₁₆⁽¹⁾ to C₁₆⁽⁸⁾) in its timeslot from the ACC channel information, if the UE learns that the base station transmits signals using beam forming according to the system information broadcasted over BCH, it will compare the channelisation codes corresponding to the 3 detected midambles m⁽¹⁾, m⁽³⁾ and m⁽⁴⁾ with the 8 channelisation codes in the ACC information according to the mapping between midambles and channelisation codes in default midambles, to determine whether to cancel C₁₆⁽³⁾ and C₁₆⁽⁴⁾ from the list of channelisation codes. Thus the UE should utilize the 6 effective channelisation codes for implementing JD.

V The Higher-Layer Signaling Procedure of Processing and Transferring ACC Information

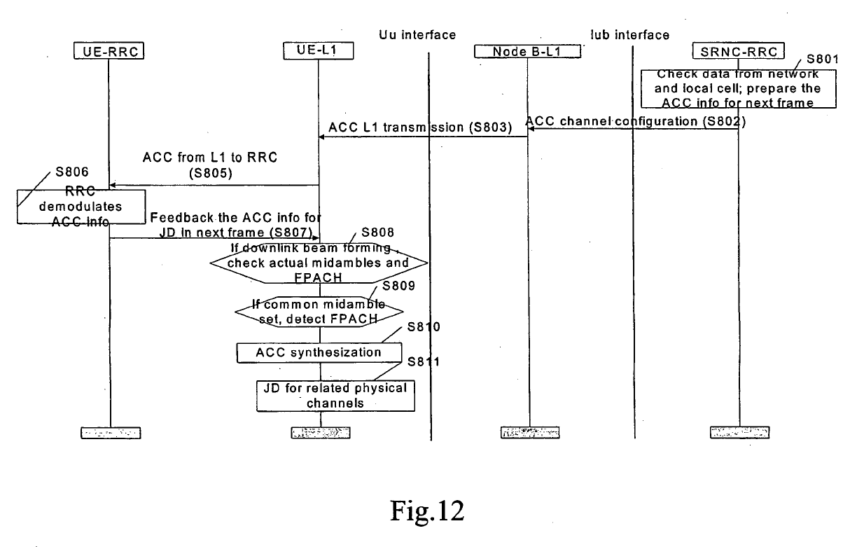

The above section discusses the proposed method for transferring ACC information by exploiting the ACC dedicated channel in TS0, the method for acquiring the initial ACC information during UE call setup procedure, and the method for acquiring accurate channelisation codes information when common midamble and beam forming are used in the cell. Detailed description will be given in the following to the above signaling transferring procedure for implementing JD in the present invention, in conjunction with FIG. 12.

Just as FIG. 12 shows, first, the RRC in the SRNC checks the data traffic from the network and that from the cell, which will be sent to the UEs in the cell (step S801); then, the RRC in the SRNC will allocate channelisation codes for these traffics. During this process, the SRNC can readily foresee the change of channelisation codes in the next frame (10 ms), and embed the changed channelisation codes information ACC into the associated bitmap (for example, including the 6*16 bit bitmap), thus the ACC dedicated channel can be constructed with the ACC information (step S802). Next, L1 of the UTRAN (or namely the physical layer of Node B) sends the ACC information via the ACC dedicated channel in the fixed timeslot TS0, by using the two code channels C₁₆⁽⁵⁾ and C₁₆⁽⁶⁾ (step S803). It should be noted that the UTRAN always broadcasts the ACC information omni-directionally regardless whether the UE is willing to accept the ACC information or not.

If L1 of the UE receives the information delivered via the ACC channel during call setup procedure, JD will be performed on the ACC dedicated channel by using the above primary and secondary channelisation codes, to get the initial ACC information for the next frame, and the initial ACC information will be sent to the RRC layer of the UE. If it occurs during communication procedure, JD will be performed on the ACC channel in the current frame by using the ACC information read from the previous frame via the ACC channel, to get the ACC information of the next frame, and the ACC information will be sent to the RRC layer of the UE (step S805).

After receiving the ACC information (the initial ACC information, or the ACC information for the next frame) from L1, the RRC of the UE will conduct processing (including de-interleaving) on the ACC (step S806), and feedback the processed ACC information for use in JD of the next frame to L1 (step S807).

After the L1 of the UE obtains the above feedback ACC information, first it will check whether downlink beam forming is applied in the cell according to the received system information broadcasted over BCH. If downlink beam forming is applied, the UE physical layer can obtain the actually received effective channelisation codes according to the active midamble gotten through channel estimation and the ACC read from the ACC dedicated channel of the previous frame, and detect whether the FPACH in the UE's timeslot is active through channel estimation according to the midamble shift (step S808). If no downlink beam forming is applied in the cell, a check should be made about whether common midamble is used in the cell (no midamble is used when beam forming is applied) according to the received system information broadcasted over BCH. If common midamble is used, detect whether the FPACH in its timeslot is active according to the default association between the midambles and channelisation codes or the specific midamble designated for the FPACH (step S809). Then, according to the judgment result of step S808 or step S809, carry out a synthetic judgment on the ACC read from the ACC dedicated channel of the previous frame (including the detection and synthesization of the FPACH in the case that the system uses non-downlink beam forming but still uses the default midamble), so as to get the accurate ACC in the current frame that are constructed by the effective ACC codes in the ACC dedicated channel of the previous frame and the active FPACH codes (step S810).

At the end, JD is performed on the related physical channels in the current frame by using the above accurate ACC (step S811).

It should be noted that the above-described ACC information acquisition method aims at UE call setup procedure and normal communication procedure, but as a matter of fact, the proposed method can be extended to UE call termination and cell handover procedure. Moreover, the period for the UE to read the ACC code channels is not limited to 10 ms, and can be 20 ms or 40 ms according to the difference of the allocated TTI. Furthermore, the proposed method can be applied in TDD systems of 3.84 Mbps and 7.86 Mbps after very slight modifications.

With regards to the above-described method for acquiring ACC information in TD-SCDMA system, it can be implemented in computer software or computer hardware, or in combination of both.

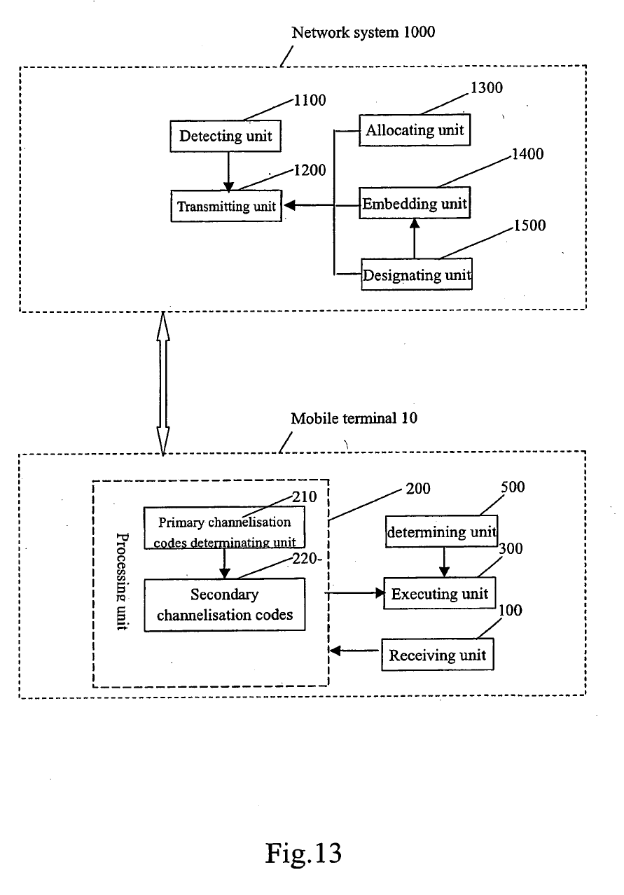

Referring to the block diagram of the method for acquiring ACC information in TD-SCDMA system to perform JD algorithm in accordance with an embodiment of the present invention, the network system and UE can be illustrated in FIG. 13, wherein the same components as those in the conventional network system and UE are not given herein.

As FIG. 13 shows, first, detecting unit 1100 in network system 1000 predicts the ACC information of each timeslot in the next frame. Then, transmitting unit 1200 sends the ACC information in TS0 via an ACC dedicated channel, for example, utilizing two channelisation codes C₁₆⁽⁵⁾ and C₁₆⁽⁶⁾. As to the setup of the ACC dedicated channel, it can be referred to the above section about the ACC dedicated channel setup.

Network system 1000 also includes an allocating unit 1300, which only allows access of a new UE at the header of the second frame and subsequent ones in a TTI.

If the communication protocol is modified such that TS0 has to use fixed channelisation codes allocation scheme, allocating unit 1300 allocates a primary channelisation code to a UE along with the corresponding secondary channelisation code, thus the UE can obtain the secondary channelisation code according to the detected primary channelisation code.

Network system 1000 also includes an embedding unit 1400, for embedding the secondary channelisation codes to be used in TS0 of the next frame into the reserved bits of the FPACH information so that UEs can acquire the secondary channelisation codes information according to the FPACH information.

Network system 1000 also includes a designating unit 1500, for designating a specific midamble to the FPACH channel when common midamble is used in the cell and embedding unit 1400 embeds the designated information into the system information.

Through transmitting unit 1200, network system 1000 sends the ACC information of the next frame to each UE via the ACC dedicated channel.

UE 10 comprises: a receiving unit 100, for receiving downlink signals from a network system in a specific timeslot (such as TS0); a processing unit 200, for processing the downlink signals, to get the active primary and secondary channelisation codes in the timeslot; an executing unit 300, for performing a JD algorithm on the downlink signals by using the primary and secondary channelisation codes, to get the initial ACC information for use in JD in the next frame.

Wherein, processing unit 200 comprises: primary channelisation codes determining unit 210, for performing channel estimation on said downlink signals, to get the active primary channelisation codes in said timeslot; secondary channelisation codes determining unit 220, for determining the active secondary channelisation codes in the specific timeslot according to the association between the primary and secondary channelisation codes in the above channelisation codes allocation rule, or determining the active secondary channelisation codes in the specific timeslot according to the secondary channelisation codes indication constructed by the reserved bits in the above FPACH information.

Executing unit 300 executes step S805 in FIG. 12. If the UE is in call setup procedure, it will perform JD on the ACC dedicated channel by using the primary and secondary channelisation codes, to get the initial ACC information for use in the next frame, and send the initial ACC information to the RRC layer of the UE. If the UE is in communication procedure, JD will be conducted on the ACC channel of the current frame by using the ACC information read from the ACC channel in the previous frame, to get the ACC information for use in the next frame, and send the ACC information to the RRC layer of the UE. As to the setup of the ACC dedicated channel, it can be referred to the related section above.

After receiving the ACC information (the initial ACC information, or the ACC information for use in the next frame) from the physical layer, the RRC of the UE conducts processing (including interleaving) on the ACC, and feeds the processed ACC information for use in the JD of the next frame back to the physical layer.

After the UE's physical layer gets the above feedback ACC information, determining unit 500 determines whether downlink beam forming is applied in the cell according to the system information broadcasted over BCH. If downlink beam forming is applied, it will acquire the actually received effective ACC according to the active midamble obtained through channel estimation and the ACC read from the ACC dedicated channel of the previous frame, and determine whether the FPACH in the UE's timeslot is active through channel estimation and in accordance with the midamble shift (if the FPACH possibly exists).

If no beam forming is applied in the cell, determining unit 500 determines whether common midamble is used in the cell (no common midamble will be used when beam forming is applied) according to the received system information broadcasted over BCH. If common midamble is used, it will detect whether the FPACH in its timeslot is active according to the default specification between the midambles and the number of the code channel or the specific midamble designated for the FPACH.

Then, determining unit 500 will carry out a synthetic judgment on the ACC read from the ACC dedicated channel of the previous frame (including the detection and synthesization of the FPACH when the system adopts non-downlink beam forming but still uses the default midamble) according to the above judgment result, to get the accurate active channelisation codes in the current frame constructed by the effective ACC in the ACC dedicated channel of the previous frame and the active FPACH codes.

In the last, executing unit 300 performs JD on the related physical channels in the current frame by using the above accurate ACC, to demodulate the information from the network system.

Wherein executing unit 300 reads the ACC information transferred by the network system via the ACC dedicated channel at least in every radio frame.

In network system 1000 as illustrated in FIG. 13, detecting unit 1100, allocating unit 1300, embedding unit 1400 and designating unit 1500, and processing unit 200, executing unit 300 and determining unit 500 in UE 10, can be readily implemented by those skilled in the art in accordance with what is described above in the present invention.

### BENEFICIAL RESULTS OF THE INVENTION

As the above descriptions go to the embodiments of the present invention in conjunction with accompanying drawings, with respect to the proposed method and apparatus for implementing downlink JD in TDD CDMA communication systems, two code channels in TS0 are taken as the ACC dedicated channel to broadcast the ACC information, thus the load of other physical channels won't be increased and the data transmission rate and quality won't be reduced.

Meanwhile, with regard to the proposed method and apparatus for acquiring ACC information during UE call setup procedure, UE can readily acquire the initial ACC information during call setup procedure and at the same time other UEs conducting normal communication can also learn whether there exists FPACH in its timeslot so as to accurately acquire the channelisation codes information, according to the allocation rule that two radio resource units are fixedly allocated to a channel or the method for combining midamble detection with the information read from the reserved bits of the FPACH.

Moreover, when common midamble is used in the cell, UE can determine whether there exists FPACH in the timeslot and acquire the channelisation codes information in the case of common midamble according to the mapping relationship between the number of channelisation codes and midamble shift, through designating specific midamble for the FPACH or changing the used common midamble by the UTRAN's physical layer based on whether there exists FPACH. Therefore, the method and apparatus proposed in the present invention is not limited to the fixed relationship between the midambles and the channelisation codes, but applicable to various midamble allocation schemes in 3GPP standards.

Furthermore, the proposed method and apparatus for implementing downlink JD takes account of the case where the base station adopts downlink beam forming. The actual channelisation codes information in the case of downlink beam forming can be acquired through comparing the channelisation codes corresponding to the detected midambles with the channelisation codes transferred over the ACC dedicated channel.

It is to be understood by those skilled in the art that the method and apparatus for implementing downlink JD for use in TDD CDMA communication systems as disclosed in this invention can be modified without departing from the spirit and scope of the invention as defined by the appended claims.

What is claimed is:

1. A method for implementing downlink JD (Joint Detection) in TDD CDMA communication systems to be performed in the UE, comprising the steps of:
(a) receiving downlink signal from a network system in a specific timeslot;
(b) obtaining an active primary and secondary channelisation codes in the specific timeslot, through processing the downlink signal;
(c) acquiring the initial ACC (Active Channelisation Codes) information for use in implementing JD in next radio frame, through implementing a JD algorithm on the downlink signal by using the primary and secondary channelisation codes.

2. The method according to claim 1, wherein step (b) includes:
(b1) performing channel estimation on the downlink signal to get the active primary channelisation codes in the specific timeslot;
(b2) determining the active secondary channelisation codes in the specific timeslot according to the association between the primary and secondary channelisation codes predefined in the channelisation codes allocation rule.

3. The method according to claim 1, wherein step (b) includes:
(b1) performing channel estimation on the downlink signal to get the active primary channelisation codes in the specific timeslot;
(b2) determining the active secondary channelisation codes in the specific timeslot according to indication information of the secondary channelisation codes constructed by reserved bits in specific downlink information.

4. The method according to claim 3, wherein the specific downlink information is FPACH (Fast Physical Access Channel) information.

5. The method according to claim 1, wherein step (c) includes:
performing JD algorithm on the downlink signal transferred over an ACC dedicated channel by using the primary and secondary channelisation codes to get the initial ACC information; wherein the ACC dedicated channel is the pre-selected code channels in the specific timeslot.

6. The method according to claim 5, wherein the pre-selected code channels are two code channels, and the midamble corresponding to a pair of channelisation codes used by the two code channels is different from the midamble used by BCH, and different from the midambles reserved by the base station when BCH adopts transmit diversity.

7. The method according to claim 6, further comprising the step of:
performing JD algorithm on the ACC dedicated channel in the next radio frame by using the initial ACC information to get the ACC information for subsequent radio frame;
performing a JD algorithm on the signal received in the next radio frame from the network system by using the initial ACC information to demodulate the information from the network system.

8. The method according to claim 6 or 7, further comprising the step of:
performing JD algorithm on the ACC dedicated channel in a radio frame by using the ACC information obtained in a previous radio frame to get the ACC information for the subsequent radio frame;
performing JD algorithm on the signal received in the radio frame from the network system by using the ACC information obtained in the previous radio frame to demodulate the information from the network system.

9. The method according to claim 8, further comprising the step of:
receiving the system information from the network system;
determining whether there is a FPACH according to the system information;
determining whether the FPACH is activated according to the midamble shift in the system information, if there is the FPACH.

10. The method according to claim 9, further comprising the step of:
determining whether the network system adopts common midamble to transmit signal, according to the system information;
determining whether the FPACH is activated according to the association between the number of channelisation codes and the midamble shift and the ACC information, if common midamble is adopted to transmit signal.

11. The method according to claim 9, further comprising the step of:
determining whether the network system adopts common midamble to transmit signal according to the system information;
determining whether the FPACH is activated according to the association between the specific midamble designated in the system information and the FPACH, if common midamble is adopted to transmit signal.

12. The method according to any of claim 9 to 11, further comprising the step of:
performing a JD algorithm on the signal received in the downlink timeslot received from the network system, according to the ACC information and the channelisation codes of the active FPACH.

13. The method according to claim 12, further comprising the step of:
determining whether the network system adopts beam forming to transmit signal, according to the system information;
if beam forming is adopted to transmit signal, performing a JD algorithm on the signal received in the downlink timeslot from the network system by using the ACC corresponding to the detected midamble in the ACC information to demodulate the information from the network system.

14. The method according to claim 13, further comprising the step of:
reading the ACC information transferred by the network system over the ACC dedicated channel, at least in every radio frame.

15. A method of implementing downlink JD for use in TDD CDMA communication network system, comprising the steps of:
predicting ACC information of each timeslot in a next radio frame;
transmitting the ACC information in a specific timeslot via an ACC dedicated channel constructed by pre-selected code channels.

16. The method according to claim 15, further comprising the step of:
only permitting a new UE to access at the header of a second frame and subsequent frame in a TTI (transmission time interval); wherein the pre-selected code channels are two code channels in the specific timeslot, and the midamble corresponding to a pair of channelisation codes used by the two code channels is different from the midamble used by BCH, and is also different from the midambles reserved by the BS when BCH adopts transmit diversity.

17. The method according to claim 16, wherein:
only permitting the UE to access at the beginning of next TTI, if the TTI is the allowable shortest time interval in the communication protocol.

18. The method according to claim 17, wherein the shortest time interval is 10 ms.

19. The method according to claim 16, further comprising the step of:
allocating a primary channelisation code together with corresponding secondary channelisation code to a UE so that the UE can obtain the secondary channelisation code according to the detected primary channelisation code.

20. The method according to claim 16, further comprising the step of:
embedding information of secondary channelisation codes to be used in the specific timeslot in the next radio frame into the reserved bits of FPACH information so that the UE can obtain the information of secondary channelisation codes from the FPACH information.

21. The method according to claim 19 or 20, further comprising the step of:
designating a specific midamble to the FPACH;
embedding the designation information into the system information.

22. A UE, comprising:
a receiving unit, for receiving downlink signal from a network system in a specific timeslot;
a processing unit, for processing the downlink signal to get an active primary and secondary channelisation codes in the specific timeslot;
an executing unit, for executing a JD algorithm on the downlink signal by using the primary and secondary channelisation codes to get initial ACC information for use in implementing JD in next radio frame.

23. The UE according to claim 22, wherein the processing unit includes:
primary channelisation codes determining unit, for carrying out channel estimation on the downlink signal to get the active primary channelisation codes in the specific timeslot;
secondary channelisation codes determining unit, for determining the active secondary channelisation codes in the specific timeslot according to the association between the primary and secondary channelisation codes predefined in the channelisation codes allocation rule.

24. The UE according claim 22, wherein the processing unit includes:
primary channelisation codes determining unit, for carrying out channel estimation on the downlink signal to get the active primary channelisation codes in the specific timeslot;
secondary channelisation codes determining unit, for determining the active secondary channelisation codes in the specific timeslot according to the indication information of the secondary channelisation codes constructed by the reserved bits in the FPACH information.

25. The UE according to claim 22, wherein the executing unit carries out the JD algorithm on the downlink signal transmitted by the network system over an ACC dedicated channel, by exploiting the primary and secondary channelisation codes to get the initial ACC information;
wherein the ACC dedicated channel is pre-selected code channels in the specific timeslot.

26. The UE according to claim 25, wherein the pre-selected code channels are two code channels, and the midamble corresponding to a pair of channelisation codes used by the two code channels is different from the midamble used by BCH, and is also different from the midambles reserved by the base station when BCH adopts transmit diversity.

27. The UE according to claim 26, wherein:
the executing unit is used for executing JD algorithm on the ACC dedicated channel in the next radio frame, by using the initial ACC information to get the ACC information for a subsequent radio frame; and for executing a JD algorithm on the signal received in the next radio frame from the network system by using the initial ACC information to demodulate the information from the network system.

28. The UE according to claim 27, wherein the receiving unit receives the system information from the network system, the UE further comprising:
a determining unit, for determining whether there exists a FPACH channel according to the system information, and determining whether the FPACH channel is activated according to the midamble shift in the system information.

29. The UE according to claim 28, wherein:
the determining unit judges whether the network system adopts common midamble to transmit signal according to the system information, and judges whether the FPACH channel is activated according to the association between the number of channelisation codes and midamble shift and the ACC information.

30. The UE according to claim 28, wherein:
the determining unit also judges whether the network system adopts common midamble to transmit signal according to the system information, and judges whether the FPACH channel is activated through channel estimation according to the association between the designated specific midamble in the system information and the FPACH.

31. The UE according to any one of claim 28 to 30, wherein:
the executing unit performs a JD algorithm on the signal received in the downlink timeslot from the network system according to the ACC information and the channelisation codes of the FPACH channel to demodulate the information from the network system.

32. The UE according to claim 31, wherein:
the determining unit also judges whether the network system adopts beam forming to transmit signal according to the system information;
the executing unit performs a JD algorithm on the signal received in the downlink timeslot from the network system by using the ACC information and the active channelisation codes corresponding to the detected midamble to demodulate the information from the network system.

33. The UE according to claim 32, wherein:
the executing unit reads the ACC information transferred by the network system via the ACC dedicated channel at least in every radio frame.

34. A network system, comprising:
a detecting unit, for predicting an ACC information of each timeslot in the next radio frame;
a transmitting unit, for transmitting the ACC information in a specific timeslot via an ACC dedicated channel constructed by the pre-selected code channels.

35. The network system according to claim 34, further comprising:
an allocating unit, for only permitting a new UE to access at header of a second frame and subsequent frame in a TTI;
wherein the pre-selected code channels are two code channels in the specific timeslot, and the midamble corresponding to a pair of channelisation codes used by the two code channels is different from the midamble used by BCH broadcast, and also different from the midamble reserved by the base station when BCH adopts transmit diversity.

36. The network system according to claim 35, wherein:
only permitting the new UE to access at the beginning of next TTI, if the TTI is the allowable shortest time interval in the communication protocol.

37. The network system according to claim 36, wherein:
the allocating unit allocates a primary channelisation code along with its corresponding secondary channelisation code to the UE, so that the UE can obtain the secondary channelisation code according to the detected primary channelisation code.

38. The network system according to claim 37, further comprising:
an embedding unit, for embedding the secondary channelisation codes information to be used in the specific timeslot in the next radio frame into the reserved bits in the FPACH information so that the UE can obtain the secondary channelisation codes information from the FPACH information.

39. The network system according to claim 37 or 38, further comprising:
a designating unit, for designating a specific midamble to the FPACH channel;
and the embedding unit embeds the designation information into the system information.
